(19) United States
(12) Patent Application Publication
(10) Pub. No.: US 2025/0010850 A1
(43) Pub. Date: Jan. 9, 2025

(54) Device and Method for Controlling Travel

(71) Applicants: Hyundai Motor Company, Seoul (KR); Kia Corporation, Seoul (KR)

(72) Inventor: Hae Ryong Lee, Seoul (KR)

(21) Appl. No.: 18/536,624

(22) Filed: Dec. 12, 2023

(30) Foreign Application Priority Data
Jul. 5, 2023 (KR) 10-2023-0087217

(51) Int. Cl. B60W 30/09

(52) U.S. Cl. CPC B60W 30/09; B60W 2520/10; B60W 2554/4042; B60W 2720/106

(57) ABSTRACT

The present disclosure relates to a device and a method for controlling a vehicle. The device includes a driving controller configured to control movement of a first vehicle, and one or more processors electrically connected to the driving controller. The device further includes memory storing instructions that, when executed by the one or more processors, cause the device to determine a first travel area including a first expected travel path of the first vehicle and a second travel area including a second expected travel path of a second vehicle located within a predetermined distance from the first vehicle, determine an overlapping area between the first travel area and the second travel area, and, based on a determination that a possibility of collision between the first vehicle and the second vehicle in the overlapping area being greater than a threshold value, adjust the first expected travel path of the first vehicle or a speed of the first vehicle.

### CROSS-REFERENCE TO RELATED APPLICATION

This application claims the benefit of priority to Korean Patent Application No. 10-2023-0087217, filed in the Korean Intellectual Property Office on Jul. 5, 2023, the entire contents of which are incorporated herein by reference.

### TECHNICAL FIELD

The present disclosure relates to a device and a method for controlling travel, and more specifically, to a technology for controlling travel of a vehicle based on sensing an object outside the vehicle.

### BACKGROUND

An autonomous vehicle refers to a vehicle that may operate on its own without manipulation of a driver or a passenger. In addition, in addition to the autonomous vehicle defined based on an autonomous driving level, technologies for monitoring the outside of the vehicle to assist the driver in driving and operating various driving assistance means based on the monitored external environment of the vehicle have been proposed.

The autonomous vehicle or vehicles equipped with the driving assistance means use a technology for monitoring the outside of the vehicle to detect an object and controlling the vehicle based on a scenario determined based on the detected object. In general, the autonomous vehicle may use an avoidance travel technology to avoid the object when there is a risk of collision with the object detected outside the vehicle. In addition, it is common to use a method for determining whether a travel direction or a moving direction of the object intersects that of a host vehicle to determine a possibility of collision.

However, even when the travel direction of the object does not intersect that of the host vehicle, a dangerous situation may occur in autonomous driving and a situation that may cause the passenger to feel anxious may occur.

Therefore, a plan to promote safe driving and to more actively relieve the passengers' anxiety during the travel process is being sought.

### SUMMARY

The present disclosure has been made to solve the above-mentioned problems occurring in the prior art while advantages achieved by the prior art are maintained intact.

An aspect of the present disclosure provides a device and a method for controlling a vehicle that may further reduce a risk of collision with an external object.

Another aspect of the present disclosure provides a device and a method for controlling a vehicle that may reduce a passenger's feeling of anxiety because of an external object even when a risk of collision with the object is small.

The technical problems to be solved by the present disclosure are not limited to the aforementioned problems, and any other technical problems not mentioned herein will be clearly understood from the following description by those skilled in the art to which the present disclosure pertains.

According to one or more embodiments of the present disclosure, a device may include: a driving controller configured to control movement of a first vehicle; one or more processors electrically connected to the driving controller; and memory storing instructions that, when executed by the one or more processors, cause the device to: determine: a first travel area including a first expected travel path of the first vehicle, and a second travel area including a second expected travel path of a second vehicle located within a predetermined distance from the first vehicle; determine an overlapping area between the first travel area and the second travel area; and based on a determination that a possibility of collision between the first vehicle and the second vehicle in the overlapping area being greater than a threshold value, adjusting at least one of: the first expected travel path of the first vehicle, or a speed of the first vehicle.

The instructions, when executed by the one or more processors, may cause the device to determine the first travel area by determining an area within a range having a first offset in a lateral direction from the first expected travel path. The instructions, when executed by the one or more processors, may cause the device to determine the second travel area by determining an area within a range having a second offset in the lateral direction from the second expected travel path.

The instructions, when executed by the one or more processors, may further cause the device to determine, based on a center line of a lane, at least the first expected travel path or the second expected travel path.

The instructions, when executed by the one or more processors, may further cause the device to: adjust the first offset based on a curvature of the first expected travel path; and adjust the second offset based on a curvature of the second expected travel path.

The instructions, when executed by the one or more processors, may further cause the device to: adjust the first offset based on the speed of the first vehicle; and adjust the second offset based on a speed of the second vehicle.

The instructions, when executed by the one or more processors, may further cause the device to: determine a first point at an intersection between the first expected travel path and the second expected travel path; determine a second point at a location where the second vehicle first enters the overlapping area between the first travel area and the second travel area; determine a third point by projecting the second point onto the first expected travel path; and determine a reference point for determining a time for the first vehicle to enter the overlapping area. The reference point may be a point, between the first point and the third point, that the first vehicle is estimated to reach first.

The instructions, when executed by the one or more processors, may further cause the device to: determine, based on an angle between the first expected travel path and the second expected travel path at the intersection, a direction of approach by the second vehicle; and determine the second point by determining an earliest point of overlap between the first travel area and the second travel area.

The instructions, when executed by the one or more processors, may further cause the device to: determine a first time at which the first vehicle is estimated to reach the reference point; determine a danger period including the first time; and estimate the possibility of collision by determining whether the danger period includes a second time at which the second vehicle is estimated to reach the overlap area.

The instructions, when executed by the one or more processors, further cause the device to: determine, based on the possibility of collision, a drivable area by excluding the overlapping area from the first travel area; and adjust the first expected travel path based on the drivable area.

The instructions, when executed by the one or more processors, further cause the device to decelerate the first vehicle based on a determination that the adjusted first expected travel path extends beyond the drivable area.

According to one or more example embodiments of the present disclosure, a method may include: determining: a first travel area including a first expected travel path of a first vehicle, and a second travel area including a second expected travel path of a second vehicle located within a predetermined distance from the vehicle; determining an overlapping area between the first travel area and the second travel area; determining a possibility of collision, in the overlapping area, between the first vehicle and the second vehicle being greater than a threshold value; and causing, based on a determination that the possibility of collision satisfies a second threshold value, the first vehicle to perform an evasive maneuver.

Determining the first travel area includes determining the second travel area by determining an area within a range having a first offset in a lateral direction from the first expected travel path. Determining the second travel area by determining an area within a range having a second offset in the lateral direction from the second expected travel path.

The method may further include: determining, based on a center line of a lane, at least the first expected travel path or the second expected travel path.

The method may further include: adjusting the first offset based on a curvature of the first expected travel path; and adjusting the second offset based on a curvature of the second expected travel path.

The method may further include: adjusting the first offset based on a speed of the first vehicle; and adjusting the second offset based on a speed of the second vehicle.

The method may further include: determining a first point at an intersection between the first expected travel path and the second expected travel path; determining a second point at a location where the second vehicle first enters the overlapping area between the first travel area and the second travel area; determining a third point by projecting the second point onto the first expected travel path; and determining a reference point for determining a time for the first vehicle to enter the overlapping area. The reference point may be a point, between the first point and the third point, that the first vehicle is estimated to reach first.

The method may further include: determining, based on an angle between the first expected travel path and the second expected travel path at the intersection, a direction of approach by the second vehicle; and determining the second point by determining an earliest point of overlap between the first travel area and the second travel area.

The method may further include: determining a first time at which the first vehicle is estimated to reach the reference point; determining a danger period including the first time; and estimating the possibility of collision by determining whether the danger period includes a second time at which the second vehicle is estimated to reach the overlap area.

The method may further include: determining, based on the possibility of collision, a drivable area by excluding the overlapping area from the first travel area; and adjusting the first expected travel path based on the drivable area.

The method may further include: decelerating the first vehicle based on a determination that the adjusted first expected travel path extends beyond the drivable area.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram showing a configuration of a travel control device according to an embodiment of the present disclosure;

FIG. 2 is a diagram showing a vehicle equipped with a travel control device according to an embodiment of the present disclosure;

FIG. 3 is a flowchart for illustrating a travel control method according to an embodiment of the present disclosure;

FIG. 4 is a diagram for illustrating a method for setting a travel area;

FIG. 5 is a diagram for illustrating a method for determining an overlapping area according to an embodiment of the present disclosure;

FIG. 6 is a diagram for illustrating a method for setting an overlapping area according to another embodiment of the present disclosure;

FIG. 7 is a diagram for illustrating a method for determining a risk of collision;

FIGS. 8 to 10 are diagrams for illustrating a method for modifying an expected travel path according to an embodiment of the present disclosure;

FIGS. 11 to 13 are diagrams for illustrating a method for modifying an expected travel path according to another embodiment of the present disclosure;

FIGS. 14 and 15 are diagrams for illustrating a vehicle control method according to an embodiment of the present disclosure;

FIG. 16 is a flowchart for illustrating a vehicle control method according to another embodiment of the present disclosure; and

FIG. 17 shows a computing system according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

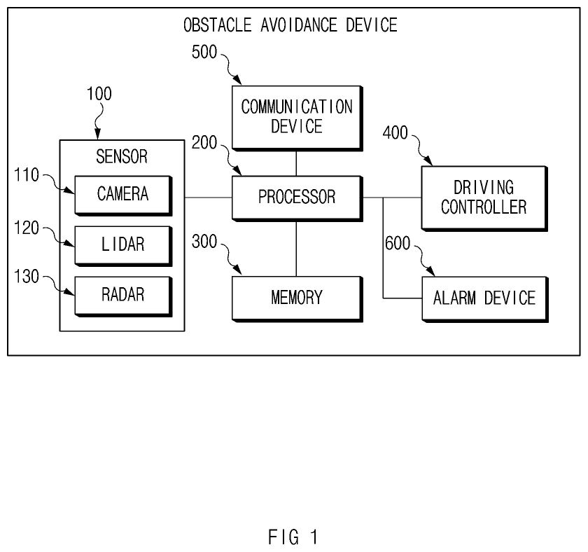

Hereinafter, embodiments of the present disclosure will be described in detail with reference to FIGS. 1 to 17.

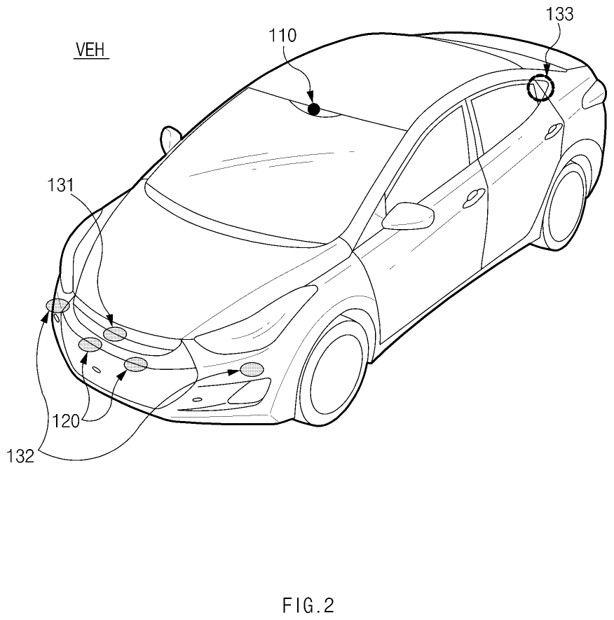

FIG. 1 is a block diagram showing a configuration of a travel control device according to an embodiment of the present disclosure, and FIG. 2 is a diagram showing a vehicle equipped with a travel control device according to an embodiment of the present disclosure.

Referring to FIGS. 1 and 2, a travel control device according to an embodiment of the present disclosure may include a sensor 100, a processor 200, a memory 300, and a driving controller 400.

The sensor 100 may include at least one of a camera 110 for detecting an external object of a vehicle VEH, a light imaging detection and ranging (LIDAR) 120, or a radio detection and ranging (RADAR) 130.

The camera 110 is for acquiring an image of the outside of the vehicle VEH, and is able to acquire an image of an area located in front of or anterolateral to the vehicle VEH. For example, the camera 110 may be disposed around a front windshield to acquire the image of the area located in front of the vehicle VEH.

The LIDAR 120 is for transmitting a laser and determining the object using a reflected wave of the laser reflected from the object, and is able to be implemented in a time of flight (TOF) scheme or a phase-shift scheme. The LIDAR 120 may be mounted to be exposed to the outside of the vehicle and may be disposed around a front bumper or a front grille.

The RADAR 130 may include electromagnetic wave transmitting and receiving modules. The RADAR 130 may be implemented in a pulse RADAR scheme or a continuous wave RADAR scheme in terms of radio wave emission principles. The RADAR 130 may be implemented in a frequency modulated continuous wave (FMCW) scheme or a frequency shift keying (FSK) scheme based on a signal waveform among the continuous wave RADAR schemes. The RADAR 130 may include a front RADAR 131 located at a center of a front surface of the vehicle VEH, anterolateral RADARs 132 located at both ends of the front bumper, and a rear RADAR 133 located at a rear portion of the vehicle VEH.

The locations of the camera 110, the LIDAR 120, and the RADAR 130 may not be limited to the embodiment shown in FIG. 2.

In addition to those shown in the drawing, the sensor may include an ultrasonic sensor and an infrared sensor. The ultrasonic sensor may include ultrasonic wave transmitting and receiving modules. The ultrasonic sensor may detect the object based on an ultrasonic wave, and may detect a location of the detected object, a distance to the detected object, and a relative speed. The ultrasonic sensor may be disposed at an appropriate location on the exterior of the vehicle to detect the object located in front of, at the rear of, or on a side of the vehicle. The infrared sensor may include infrared light transmitting and receiving modules. The infrared sensor may detect the object based on infrared light, and detect the location of the detected object, the distance to the detected object, and the relative speed. The infrared sensor may be disposed on the exterior of the vehicle to detect the object located in front of, at the rear of, or on the side of the vehicle.

In addition, the sensor 100 may further include a brake-pedal position sensor (BPS) and an accelerator position sensor (APS) that generate a speed control command for shifting the vehicle.

The brake-pedal position sensor may output a BPS signal based on a degree of depression of a brake pedal disposed in the vehicle. As an example, the BPS signal may output data of 0 to 100 based on the depression of the brake pedal, the value of 0 may be a case in which the brake pedal is not pressed, and the value of 100 may be a case in which the brake pedal is pressed at the maximum.

The accelerator position sensor may output an APS signal based on a degree of depression of an accelerator pedal disposed in the vehicle. As an example, the APS signal may output data of 0 to 100 based on the depression of the accelerator pedal, the value of 0 may be a case in which the accelerator pedal is not pressed, and the value of 100 is a case in which the accelerator pedal is pressed at the maximum.

The processor 200 may be electrically connected to the driving controller 400 and may cause the vehicle (e.g., a host vehicle) to perform avoidance travel (e.g., an evasive maneuver) by controlling the driving controller 400 based on a travel path of a target vehicle.

To this end, the processor 200 may detect the target vehicle based on information acquired by the sensor 100 of the vehicle VEH or information provided from a communication device 500.

The processor 200 may perform artificial intelligence learning on data provided from the sensor 100 to detect the target vehicle and a dangerous vehicle. To this end, the processor 200 may include an artificial intelligence (hereinafter, referred to as AI) processor. The AI processor may learn a neural network using a pre-stored program. The neural network for detecting the target vehicle and the dangerous vehicle may be designed to simulate a brain structure of a human on a computer, and may include a plurality of network nodes having weights that simulate neurons of a neural network of the human. The plurality of network nodes may transmit and receive data based on connection relationships therebetween so as to simulate synaptic activity of the neurons that transmit and receive signals with each other via synapses. The neural network may include a deep learning model developed from a neural network model. In the deep learning model, the plurality of network nodes may transmit and receive the data based on convolutional connection relationships therebetween while locating in different layers. Examples of the neural network models may include various deep learning techniques such as a deep neural network (DNN), a convolutional deep neural network (CNN), a recurrent neural network (RNN), a restricted Boltzmann machines (RBM), a deep belief network (DBN), and a deep Q-network.

The processor 200 may determine a first travel area including a first expected travel path of the vehicle VEH. Hereinafter, a vehicle that performs travel control according to an embodiment of the present disclosure will be referred to as a host vehicle V_ego. The first expected travel path may be a line connecting a center of the host vehicle V_ego in travel to a destination. Accordingly, even when the host vehicle V_ego is traveling while maintaining a line, the first expected travel path may be partially modified based on a lateral movement of the host vehicle V_ego. When the host vehicle V_ego moves along a center of a road, the first expected travel path may coincide with a lane link of the road. The lane link may be a line (e.g., straight line or curved line) connecting center points of a lane from a location of the traveling host vehicle V_ego to the destination. In other words, the lane link may run along the center of the lane that the host vehicle V_ego is moving along towards its destination. The first travel area may refer to an area within a first offset range in a lateral direction from the first expected travel path. The lateral direction may mean a direction perpendicular to a traveling direction of the host vehicle V_ego on a road surface.

The processor 200 may determine a second travel area including a second expected travel path of a target vehicle V_tg. The second expected travel path may be a line connecting a predicted traveling direction of the target vehicle from a center of the target vehicle in travel. When a destination of the target vehicle is unknown, the second expected travel path may be limited to a path until the road diverges.

The processor 200 may determine an overlapping area between the first travel area and the second travel area. The first travel area may include an area out of the line in which the host vehicle V_ego is traveling. In addition, the second travel area may include an area out of a line in which the target vehicle is traveling. Accordingly, the overlapping area may exist even in a process in which the host vehicle V_ego and the target vehicle travel in the different lines.

When a possibility of collision is expected in the overlapping area, the processor 200 may change the first expected travel path of the host vehicle V_ego. The processor 200 may reset the first expected travel path while maintaining the line. In addition, the processor 200 may decelerate the host vehicle V_ego based on a fact that the first expected travel path is not able to be reset.

The memory 300 may store algorithms and the AI processor for operation of the processor 200. As the memory 300, a hard disk drive, a flash memory, an electrically erasable programmable read-only memory (EEPROM), a static RAM (SRAM), a ferro-electric RAM (FRAM), a phase-change RAM (PRAM), a magnetic RAM (MRAM), a dynamic random access memory (DRAM), a synchronous dynamic random access memory (SDRAM), a double date rate-SDRAM (DDR-SDRAM), and the like may be used.

The driving controller 400 is for controlling steering and deceleration and acceleration of the vehicle in response to a control signal from the processor 200, and is able to include a steering control module, an engine control module, a braking control module, and a transmission control module.

The steering control module may be divided into a hydraulic power steering (HPS) system that controls the steering using a hydraulic pressure formed by a hydraulic pump and a motor driven power steering system (hereinafter, referred to as a ‘MDPS’) that controls the steering using an output torque of an electric motor.

The engine control module is an actuator that controls an engine of the vehicle and controls the acceleration of the vehicle. The engine control module may be implemented as an engine management system (EMS). The engine control module controls a driving torque of the engine based on accelerator pedal location information output from the accelerator position sensor. The engine control module controls engine output to follow a travel speed of the vehicle requested from the processor 200 during autonomous driving.

The braking control module is an actuator that controls the deceleration of the vehicle, and is able to be implemented as an electronic stability control (ESC). The braking control module controls a braking pressure to follow a target speed requested from the processor 200. That is, the braking control module controls the deceleration of the vehicle.

The transmission control module is an actuator for controlling a transmission of the vehicle and is able to be implemented as a shift by wire (SBW). The transmission control module controls a gear shift of the vehicle based on a gear location and a gear state range.

In addition, the travel control device according to an embodiment of the present disclosure may further include the communication device 500 and an alarm device 600.

The communication device 500 may perform communication with a user terminal, another vehicle, or an external server.

The communication device 500 may support short-distance communication using at least one of Bluetooth, radio frequency identification (RFID), infrared data association (IrDA), ultra wideband (UWB), ZigBee, near field communication (NFC), wireless-fidelity (Wi-Fi), Wi-Fi Direct, or wireless universal serial bus (USB) technologies.

The communication device 500 may include a global positioning system (GPS) module or a differential global positioning system (DGPS) module for acquiring location information.

In addition, the communication device 500 may include a V2X communication module. The V2X communication module may include an RF circuit for a protocol of wireless communication with a server (vehicle to infra; V2I), another vehicle (vehicle to vehicle; V2V), or a pedestrian (vehicle to pedestrian; V2P). The communication device 500 may receive travel information of another vehicle via the V2X communication module and provide the travel information to the processor 200.

The alarm device 600 may notify a passenger of the vehicle of an obstacle determined by the processor 200, and may notify an emergency braking or an avoidance situation caused by the obstacle. The alarm device 600 may include a display, a speaker, and the like.

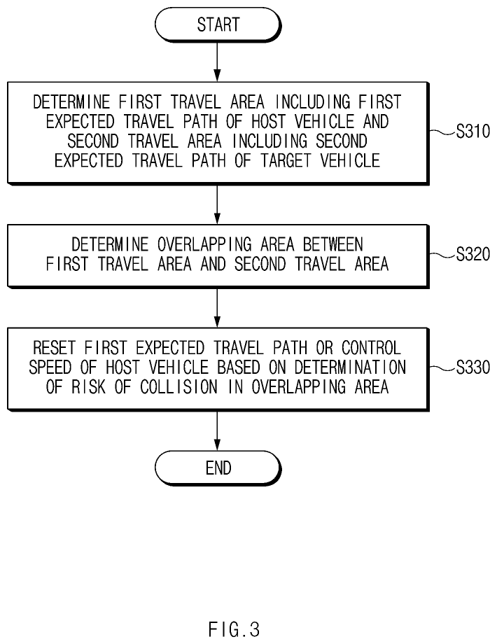

FIG. 3 is a flowchart for illustrating a travel control method according to an embodiment of the present disclosure. The embodiment shown in FIG. 3 may be procedures controlled by the processor. Hereinafter, referring to FIGS. 1 to 3, the travel control method according to the embodiment of the present disclosure will be described as follows.

In S310, the processor 200 may determine the first travel area including the first expected travel path of the host vehicle V_ego and the second travel area including the second expected travel path of the target vehicle.

The processor 200 may generate the first expected travel path based on information provided from a navigation.

The processor 200 may set the area within the first offset range in the lateral direction from the first expected travel path as the first travel area. The first offset may be set in advance and may vary according to conditions. The processor 200 may set an area within a second offset range in the lateral direction from the second expected travel path as the second travel area. The second offset may be set in advance and may vary based on conditions.

The processor 200 may set the line connecting the path from the center of the host vehicle V_ego to the destination as the expected travel path. When the vehicle is traveling at a center of a lane, the processor 200 may set the first expected travel path or a second expected travel path based on the lane link connecting the centers of one lane to each other.

In S320, the processor 200 may determine the overlapping area between the first travel area and the second travel area. Because each of the first travel area and the second travel area is not limited to an area within one lane, the overlapping area may occur even when the host vehicle V_ego and the target vehicle do not intersect each other.

The processor 200 may determine that there is a risk of collision when a deviation between a timing at which the host vehicle V_ego reaches the overlapping area and a timing at which the target vehicle reaches the overlapping area is within a critical time.

To this end, the processor 200 may calculate a first timing at which the host vehicle V_ego reaches a reference point of the overlapping area, and may calculate a danger period by applying a margin to the first timing. When the timing at which the target vehicle reaches the overlapping area is included within the danger period, the processor 200 may determine that there is the possibility of collision between the host vehicle V_ego and the target vehicle.

In S330, the processor 200 may reset the first expected travel path of the host vehicle V_ego based on the determination of the risk of collision in the overlapping area.

In addition, the processor 200 may decelerate the host vehicle V_ego based on the determination that the first expected travel path is not able to be reset.

Hereinafter, each procedure of a vehicle control method according to an embodiment of the present disclosure will be described in detail.

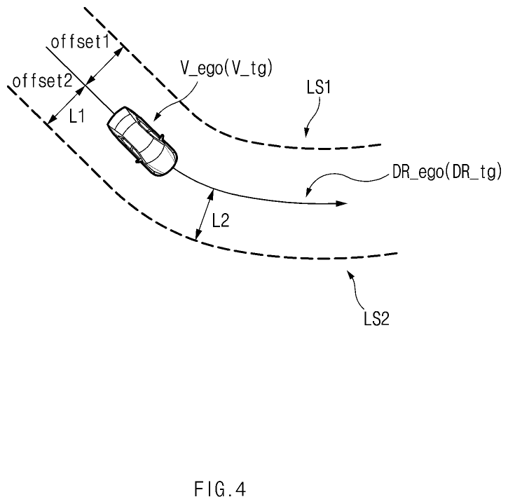

FIG. 4 is a diagram for illustrating a method for setting a travel area.

Referring to FIG. 4, the processor 200 may determine a first boundary line LS1 spaced apart by a first offset offset1 in a first direction from a first expected travel path DR_ego of the host vehicle V_ego, and determine a second boundary line LS2 spaced apart by a second offset offset2 in a second direction from the first expected travel path DR_ego. The processor 200 may determine an area inside the first boundary line LS1 and the second boundary line LS2 as the first travel area. The first offset offset1 and the second offset offset2 may be the same as or different from each other.

Similarly, the processor 200 may determine the first boundary line LS1 spaced apart by the first offset offset1 in the first direction from a second expected travel path DR_tg of the target vehicle V_tg, and determine the second boundary line LS2 spaced apart by the second offset offset2 in the second direction from the second expected travel path DR_tg. The processor 200 may determine an area inside the first boundary line LS1 and the second boundary line LS2 as the second travel area. The first offset offset1 and the second offset offset2 may be the same as or different from each other.

In addition, although FIG. 4 has been described centering on the embodiment using the same offset for setting the first travel area and the second travel area, the first travel area and the second travel area may be set using offsets of different magnitudes.

In addition, the first offset offset1 and the second offset offset2 may be determined to have different magnitudes based on a curvature. For example, the first offset offset1 and the second offset offset2 may be set to increase in proportion to the curvature. Therefore, an offset magnitude L2 in a curved section may be set greater than an offset magnitude L1 in a straight section.

In addition, the first offset offset1 and the second offset offset2 may be determined to increase in proportion to a speed of the host vehicle V_ego or the target vehicle V_tg.

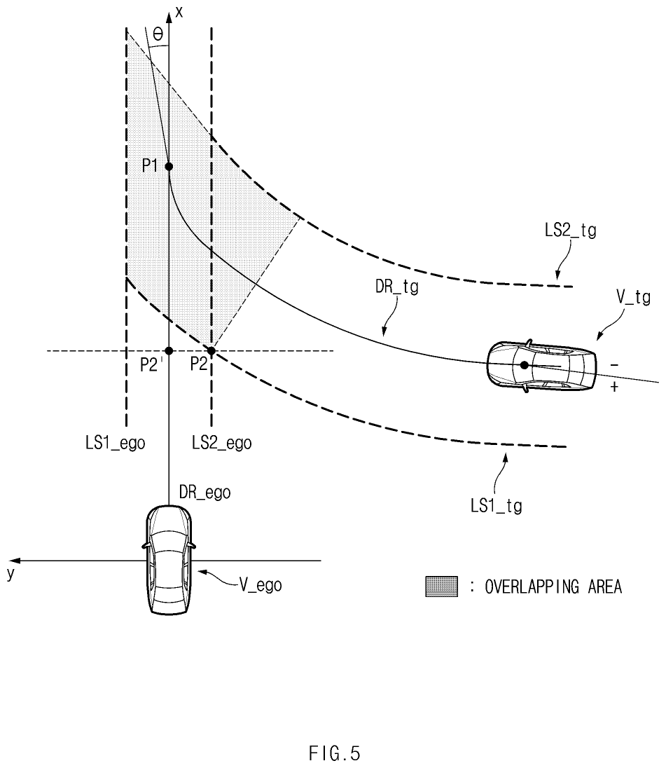

FIG. 5 is a diagram for illustrating a method for determining an overlapping area according to an embodiment of the present disclosure.

Referring to FIG. 5, a procedure for determining the overlapping area may include a procedure for determining a point where the host vehicle V_ego enters the overlapping area.

To determine the point where the host vehicle V_ego enters the overlapping area, the processor 200 may compare a point where the first expected travel path DR_ego and the second expected travel path DR_tg intersect each other with a point where the first travel area and the second travel area intersect each other. More specifically, the processor 200 may determine the point where the first expected travel path DR_ego and the second expected travel path DR_tg intersect each other as a first point P1. The processor 200 may determine a point where the target vehicle reaches first among the points where the first travel area and the second travel area intersect each other as a second point P2. The processor 200 may acquire a point P2′ by projecting the second point P2 onto the first expected travel path DR_ego. That is, if the traveling direction of the vehicle is referred to as an x-axis, the point P2′ may be determined as a point, along the first expected travel path DR_ego, having the same x coordinate as the second point P2.

The processor 200 may set a point where the host vehicle V_ego reaches first, as the reference point, among the first point P1 and the point P2′. The reference point may be a point for determining the timing at which the host vehicle V_ego enters the overlapping area.

The second point P2 may be determined as a point at which a boundary line located on a side where the target vehicle V_tg approaches among boundary lines LS1_ego and LS2_ego that determine the first travel area first meets one of boundary lines LS1_tg and LS2_tg of the second travel area. In other words, the second point P2 may be the earliest point of overlap between the first ravel area and the second travel area.

In addition, the processor 200 may determine a direction in which the target vehicle approaches (e.g., orientation of the target vehicle at the moment the target vehicle intersects with the first expected travel path DR_ego) based on a direction in which an interior angle ‘e’ between the first expected travel path DR_ego and the second expected travel path DR_tg is formed at the point at which the first expected travel path DR_ego and the second expected travel path DR_tg intersect each other. For example, when the interior angle ‘0’ between the first expected travel path DR_ego and the second expected travel path DR_tg is formed in a counterclockwise direction relative to the first expected travel path DR_ego, the processor 200 may determine that the target vehicle V_tg approaches at a direction of the first expected travel path DR_ego from a right side of the host vehicle V_ego. Similarly, when the interior angle ‘0’ between the first expected travel path DR_ego and the second expected travel path DR_tg is formed in a clockwise direction relative to the first expected travel path DR_ego, the processor 200 may determine that the target vehicle V_tg approaches the direction of the first expected travel path DR_ego from a left side of the host vehicle V_ego.

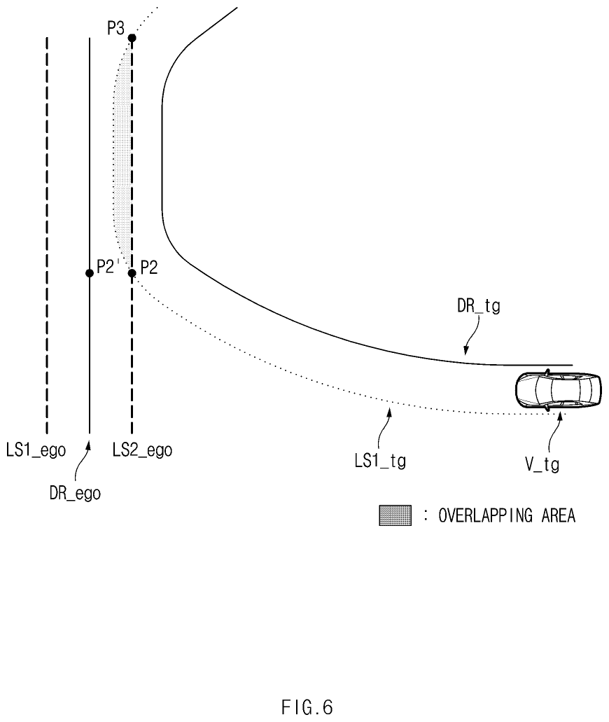

FIG. 6 is a diagram for illustrating a method for setting an overlapping area according to another embodiment of the present disclosure.

Referring to FIG. 6, when there is no point at which the first expected travel path DR_ego and the second expected travel path DR_tg intersect each other, the processor 200 may determine whether one boundary line of the first travel area and one boundary line of the second travel area intersect each other at two points. For example, the processor 200 may identify that the first boundary line LS1_tg of the second travel area intersects the second boundary line LS2_ego of the first travel area at the second point P2 and a third point P3.

A point where the target vehicle V_tg reaches first may be identified among the second point P2 and the third point P3, which are the intersection points.

When the target vehicle V_tg reaches the second point P2 first, the processor 200 may calculate a timing at which the host vehicle V_ego reaches the second point P2. To this end, the processor 200 may acquire the point P2′ by projecting the second point P2 onto the first expected travel path DR_ego, and may determine the point P2′ as the reference point.

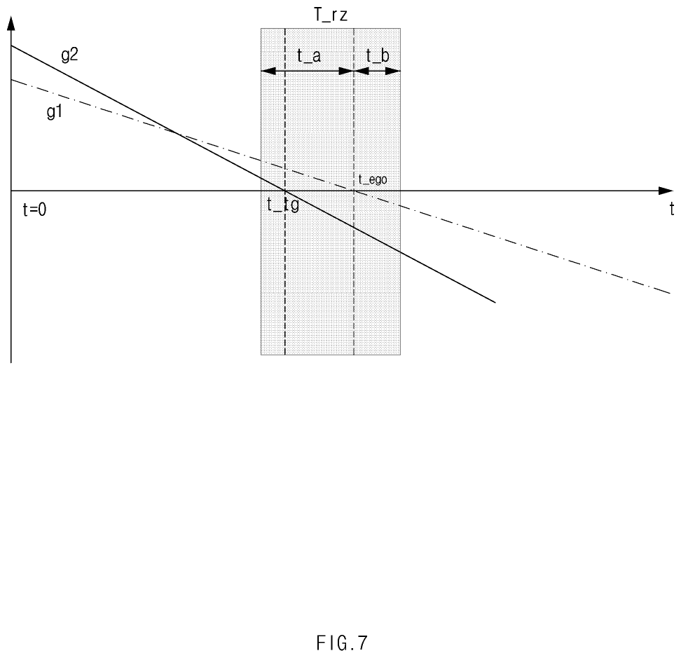

FIG. 7 is a diagram for illustrating a method for determining a risk of collision.

In FIG. 7, a horizontal axis may mean a time, and a vertical axis may mean a distance from the reference point. A positive (+) direction on the vertical axis may mean a section in which the host vehicle V_ego or the target vehicle V_tg is directed toward the reference point, and a negative (−) direction may mean a section after the host vehicle V_ego or the target vehicle V_tg passes the reference point. As described in FIGS. 5 and 6, the reference point may be the point at which the host vehicle V_ego first enters the overlapping area. g1 may be a graph showing a spacing between the host vehicle V_ego and the reference point, and g2 may be a graph showing a spacing between the target vehicle V_tg and the reference point.

The processor 200 may calculate a first timing t_ego at which the host vehicle V_ego reaches the reference point, and may calculate a danger period T_rz including the first timing t_ego. The danger period T_rz may be a period obtained by adding a first margin t_a and a second margin t_b to the first timing t_ego. The first margin t_a and the second margin t_b may have the same or different magnitudes.

When the timing at which the target vehicle V_tg first reaches the overlapping area falls within the danger period T_rz, the processor 200 may determine that there is the possibility of collision. The timing at which the target vehicle V_tg first reaches the overlapping area may be the timing at which the target vehicle V_tg reaches the second point P2, as shown in FIGS. 5 and 6.

Hereinafter, an embodiment of a vehicle control method of a host vehicle according to an embodiment of the present disclosure will be described as follows.

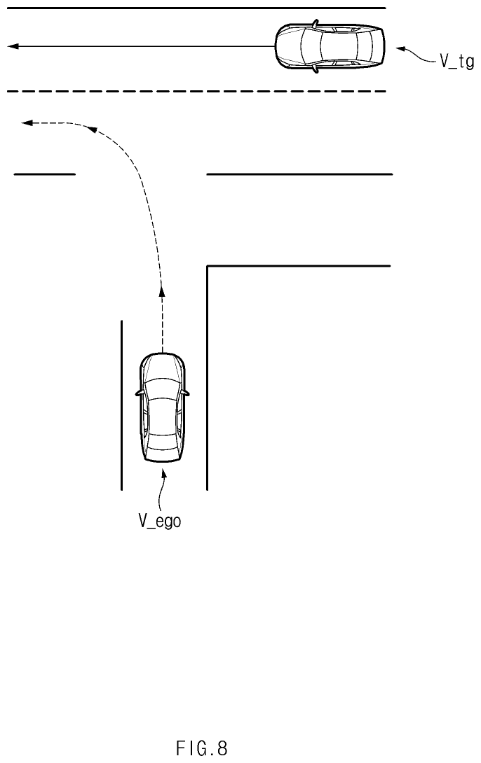

FIGS. 8 to 10 are diagrams for illustrating a method for modifying an expected travel path according to an embodiment of the present disclosure. FIGS. 8 to 10 illustrate a situation in which the target vehicle passes through an intersection by traveling straight and the host vehicle passes through the intersection by turning left travel in the same direction.

Referring to FIGS. 8 to 10, the first expected travel path DR_ego of the host vehicle V_ego may include a path leading to a first lane through the intersection with a left turn. The second expected travel path DR_tg of the target vehicle V_tg may include a path passing through the intersection by maintaining a straight line on a second lane. That is, the host vehicle V_ego and the target vehicle V_tg may not intersect each other and the lanes thereof may not overlap each other.

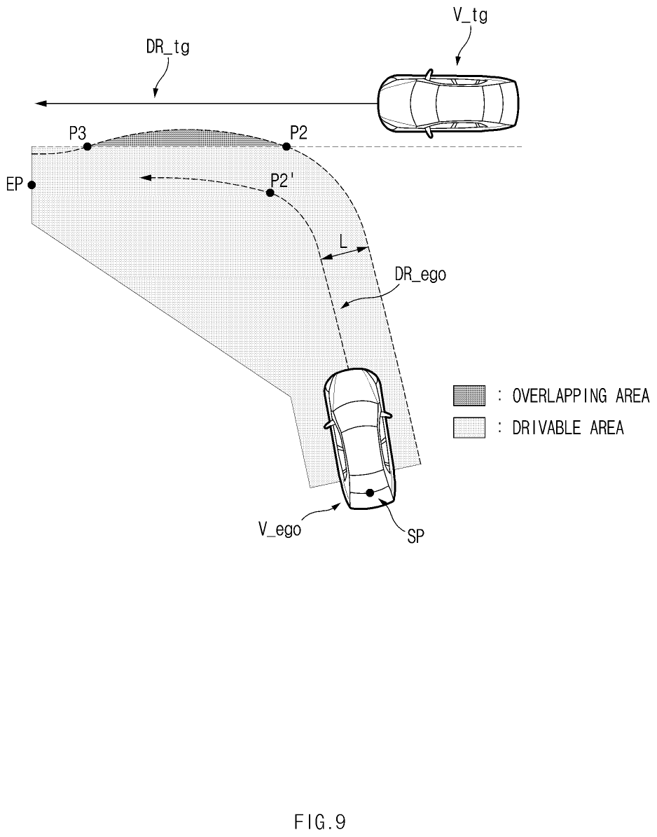

As shown in FIG. 9, even when the first expected travel path DR_ego of the host vehicle V_ego does not enter the second lane, a partial area thereof in a curved section may correspond to a second lane area. Because an offset of the curved section is set great in the process of determining the first travel area, the overlapping area in which a portion of the first travel area overlaps the second lane may occur.

The processor 200 may acquire the point P2′ by projecting the second point P2, which is a starting point of the overlapping area, onto the first expected travel path DR_ego, and calculate a timing at which the host vehicle V_ego reaches the point P2′. In addition, the processor 200 may calculate a danger period including the timing at which the host vehicle V_ego reaches the point P2′.

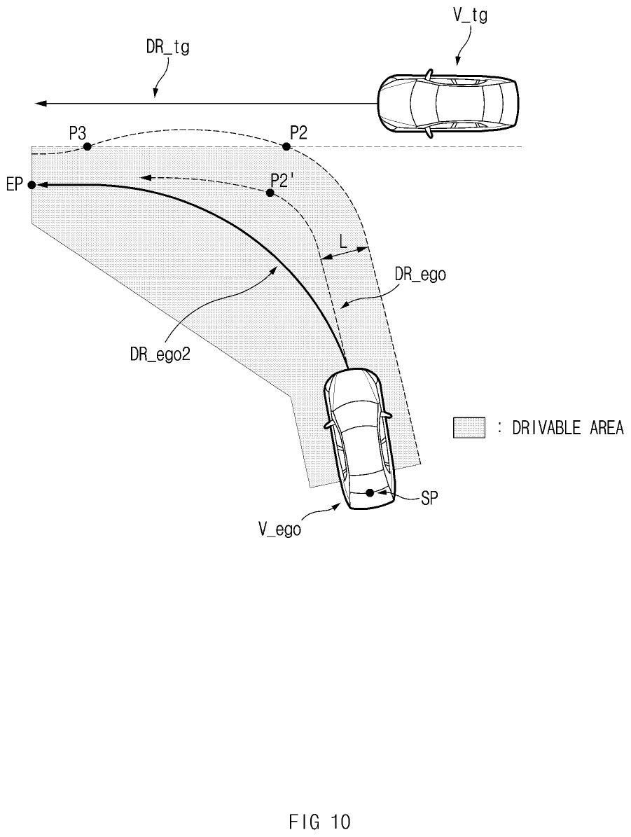

When determining that the target vehicle reaches the second point P2 within the danger period, as shown in FIG. 10, the processor 200 may acquire an expected travel path DR_ego2 changed by modifying the first expected travel path DR_ego. In addition, the processor 200 may control the driving controller 400 to travel along the changed first expected travel path DR_ego2.

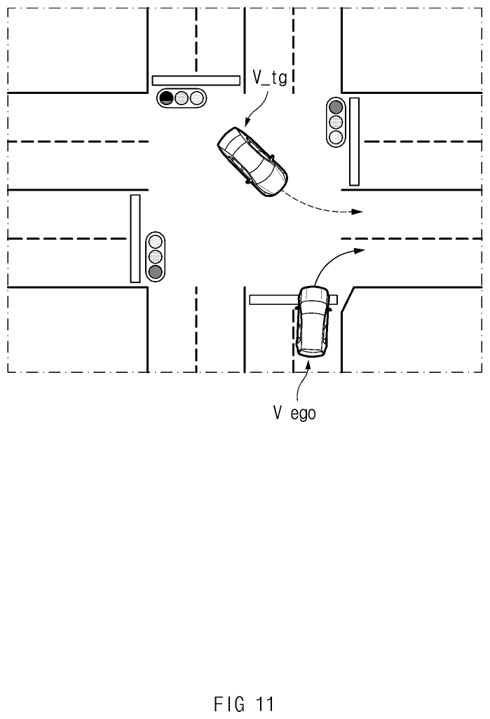

FIGS. 11 to 13 are diagrams for illustrating a method for modifying an expected travel path according to another embodiment of the present disclosure. FIGS. 11 to 13 illustrate a situation in which the target vehicle turning left at the intersection and the host vehicle turning right travel in the same direction.

Referring to FIGS. 11 to 13, the first expected travel path DR_ego of the host vehicle V_ego may include a path leading to the second lane through the intersection with the right turn. The second expected travel path DR_tg of the target vehicle V_tg may include a path leading to the first lane through the intersection with the left turn. That is, the host vehicle V_ego and the target vehicle V_tg may not intersect each other and the lanes thereof may not overlap each other.

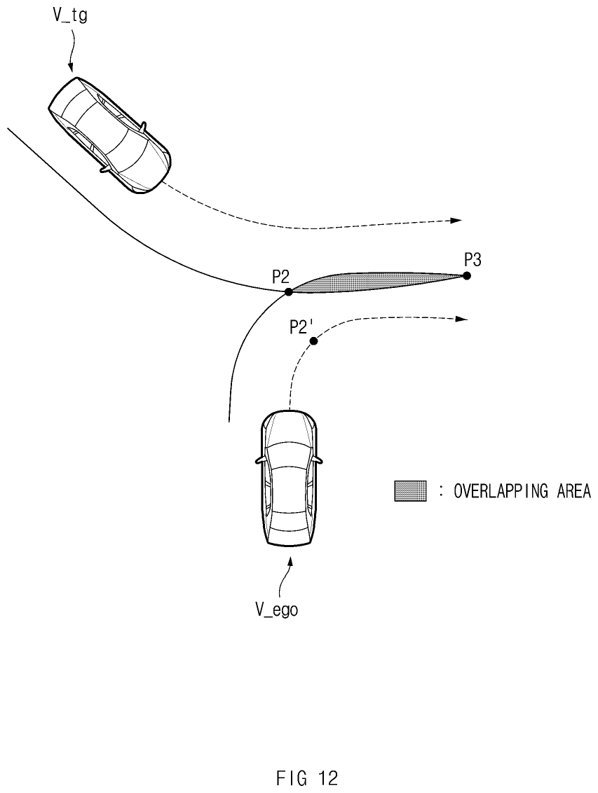

As shown in FIG. 12, even when the first expected travel path DR_ego of the host vehicle V_ego does not enter the second lane, a partial area thereof in a curved section may correspond to the second lane area. Because the offset of the curved section is set great in the process of determining the first travel area and the second travel area, the overlapping area in which the first travel area overlaps the second travel area may occur.

The processor 200 may acquire the point P2′ by projecting the second point P2, which is the starting point of the overlapping area, onto the first expected travel path DR_ego, and calculate the timing at which the host vehicle V_ego reaches the point P2′. In addition, the processor 200 may calculate the danger period including the timing at which the host vehicle V_ego reaches the point P2′.

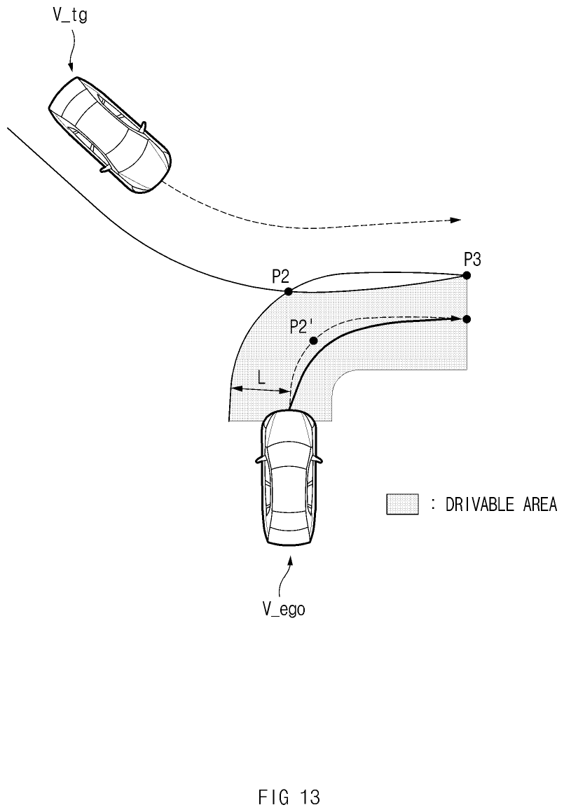

When determining that the target vehicle reaches the second point P2 within the danger period, as shown in FIG. 13, the processor 200 may acquire the expected travel path DR_ego2 changed by modifying the first expected travel path DR_ego. In addition, the processor 200 may control the driving controller 400 to travel along the changed first expected travel path DR_ego2.

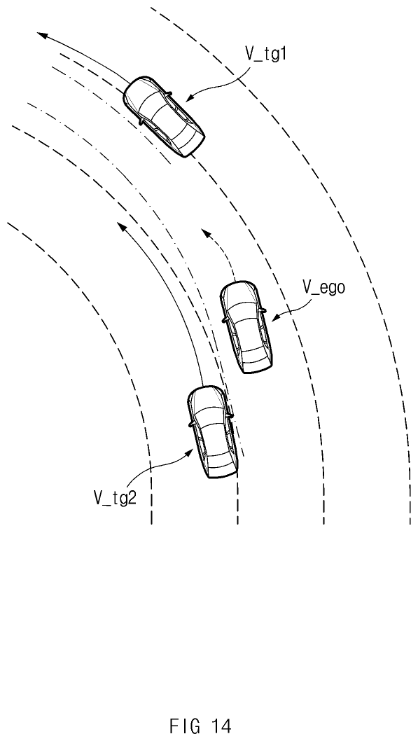

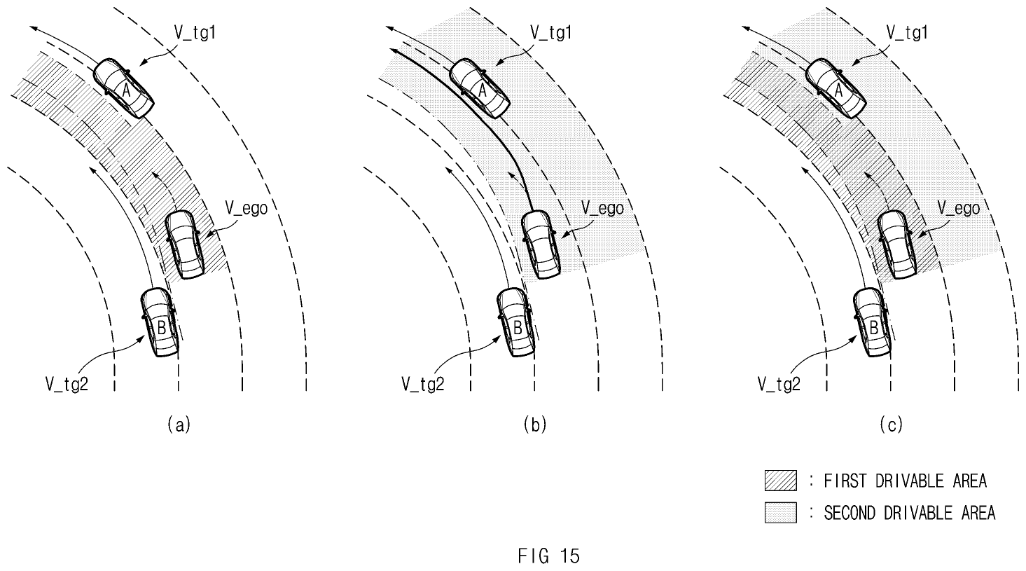

FIGS. 14 and 15 are diagrams for illustrating a vehicle control method according to an embodiment of the present disclosure. FIGS. 14 and 15 are diagrams for illustrating a situation in which target vehicles are located on both sides of a host vehicle.

Referring to FIGS. 14 and 15, a first target vehicle V_tg1 may be traveling in a right lane of the host vehicle V_ego turning in the curved section, and a second target vehicle V_tg2 may be traveling in a left lane of the host vehicle V_ego.

As shown in (a) in FIG. 15, the processor 200 may determine a first drivable area excluding the second travel area of the first target vehicle V_tg1.

In addition, as shown in (b) in FIG. 15, the processor 200 may determine a second drivable area excluding the travel area of the second target vehicle V_tg2.

In addition, as shown in (c) in FIG. 15, whether the first expected travel path of the host vehicle V_ego may be reset within an area where the first drivable area and the second drivable area overlap each other may be determined. When the first expected travel path of the host vehicle V_ego is not able to be reset in the area where the first drivable area and the second drivable area overlap each other, the processor 200 may control the driving controller 400 to decelerate the host vehicle V_ego.

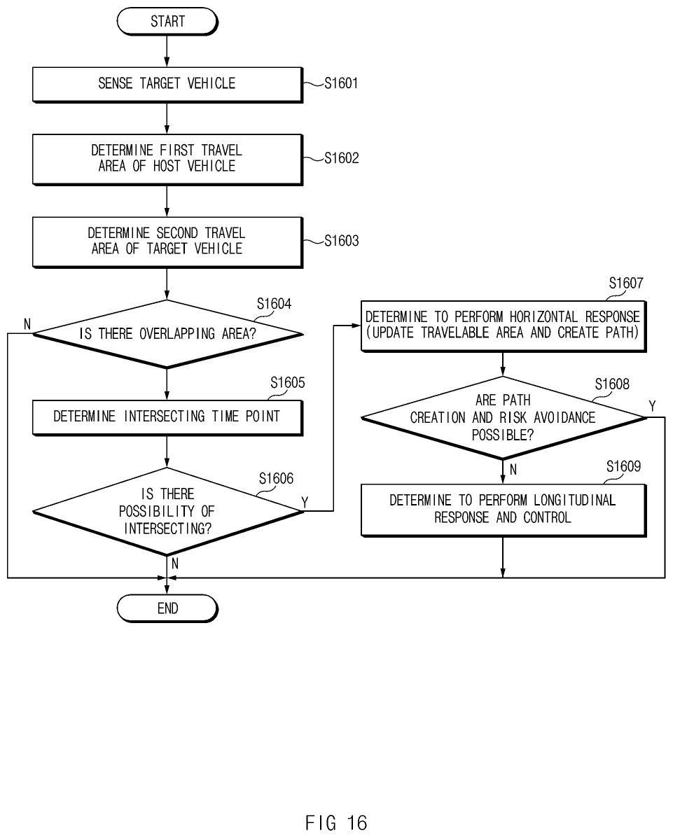

FIG. 16 is a flowchart for illustrating a vehicle control method according to another embodiment of the present disclosure. FIG. 16 may be procedures controlled by the processor. Referring to FIG. 16, the vehicle control method according to another embodiment of the present disclosure will be described as follows.

In S1601, the processor 200 may sense the target vehicle.

The processor 200 may determine a vehicle within a predetermined distance from the host vehicle V_ego as the target vehicle. Alternatively, the processor 200 may determine a vehicle whose expected travel path is within a threshold value from the first expected travel path of the host vehicle V_ego among the vehicles within the predetermined distance from the host vehicle V_ego as the target vehicle.

In S1602, the processor 200 may determine the first travel area of the host vehicle V_ego.

The processor 200 may calculate an area within an offset range in both directions of the first expected travel path of the host vehicle V_ego as the first travel area.

In S1603, the processor 200 may determine the second travel area of the target vehicle.

The processor 200 may calculate an area within an offset range in both directions of the second expected travel path of the target vehicle as the second travel area.

In S1604, the processor 200 may determine whether there is the overlapping area of the first travel area and the second travel area.

In S1605, when there is the overlapping area between the first travel area and the second travel area, the processor 200 may determine whether the host vehicle V_ego and the target vehicle intersect each other in the overlapping area.

In S1606, whether there is a possibility that the host vehicle V_ego and the target vehicle intersect each other in the overlapping area may be determined.

In S1607, based on the determination that there is the possibility that the host vehicle V_ego and the target vehicle intersect each other in the overlapping area, the processor 200 may determine whether to perform a horizontal response.

In S1608, the processor 200 may determine whether the first expected travel path may be modified within a drivable area for the horizontal response.

In S1609, when a possibility of danger is not able to be avoided by modifying the first expected travel path within the area, the processor 200 may determine a longitudinal response. That is, the processor 200 may decelerate the host vehicle V_ego.

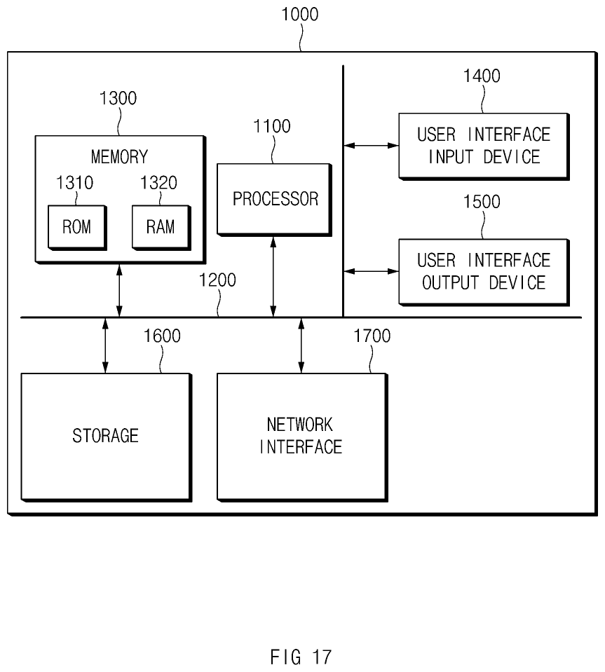

FIG. 17 shows a computing system according to an embodiment of the present disclosure.

With reference to FIG. 17, a computing system 1000 may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present disclosure, and various modifications and changes may be made by those skilled in the art without departing from the essential characteristics of the present disclosure.

Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

According to the embodiment of the present disclosure, even when the expected travel path does not intersect the expected travel path of the target vehicle, the risk of collision may be prevented in advance by modifying the expected travel path based on whether the travel areas including the expected travel paths overlap each other.

In addition, according to the embodiment of the present disclosure, as the travel area is set in consideration of the curvature of the travel path, the speed, or the like, a separation distance from the target vehicle may be increased in the case of a sharp curve section or high speed to lower the risk of collision and to more actively resolve the passenger's anxiety.

In addition, various effects identified directly or indirectly through the present document may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

1. A device comprising:
a driving controller configured to control movement of a first vehicle;
one or more processors electrically connected to the driving controller; and
memory storing instructions that, when executed by the one or more processors, cause the device to:
determine:
a first travel area comprising a first expected travel path of the first vehicle, and
a second travel area comprising a second expected travel path of a second vehicle located within a predetermined distance from the first vehicle;
determine an overlapping area between the first travel area and the second travel area; and
based on a determination that a possibility of collision between the first vehicle and the second vehicle in the overlapping area being greater than a threshold value, adjusting at least one of:
the first expected travel path of the first vehicle, or
a speed of the first vehicle.

2. The device of claim 1, wherein the instructions, when executed by the one or more processors, cause the device to determine the first travel area by determining an area within a range having a first offset in a lateral direction from the first expected travel path, and
wherein the instructions, when executed by the one or more processors, cause the device to determine the second travel area by determining an area within a range having a second offset in the lateral direction from the second expected travel path.

3. The device of claim 2, wherein the instructions, when executed by the one or more processors, further cause the device to determine, based on a center line of a lane, at least the first expected travel path or the second expected travel path.

4. The device of claim 2, wherein the instructions, when executed by the one or more processors, further cause the device to:
adjust the first offset based on a curvature of the first expected travel path; and
adjust the second offset based on a curvature of the second expected travel path.

5. The device of claim 2, wherein the instructions, when executed by the one or more processors, further cause the device to:
adjust the first offset based on the speed of the first vehicle; and
adjust the second offset based on a speed of the second vehicle.

6. The device of claim 2, wherein the instructions, when executed by the one or more processors, further cause the device to:
determine a first point at an intersection between the first expected travel path and the second expected travel path;
determine a second point at a location where the second vehicle first enters the overlapping area between the first travel area and the second travel area;
determine a third point by projecting the second point onto the first expected travel path; and
determine a reference point for determining a time for the first vehicle to enter the overlapping area, wherein the reference point is a point, between the first point and the third point, that the first vehicle is estimated to reach first.

7. The device of claim 6, wherein the instructions, when executed by the one or more processors, further cause the device to:
determine, based on an angle between the first expected travel path and the second expected travel path at the intersection, a direction of approach by the second vehicle; and
determine the second point by determining an earliest point of overlap between the first travel area and the second travel area.

8. The device of claim 6, wherein the instructions, when executed by the one or more processors, further cause the device to:
determine a first time at which the first vehicle is estimated to reach the reference point;
determine a danger period comprising the first time; and
estimate the possibility of collision by determining whether the danger period comprises a second time at which the second vehicle is estimated to reach the overlap area.

9. The device of claim 1, wherein the instructions, when executed by the one or more processors, further cause the device to:
determine, based on the possibility of collision, a drivable area by excluding the overlapping area from the first travel area; and
adjust the first expected travel path based on the drivable area.

10. The device of claim 9, wherein the instructions, when executed by the one or more processors, further cause the device to decelerate the first vehicle based on a determination that the adjusted first expected travel path extends beyond the drivable area.

11. A method comprising:
determining:
a first travel area comprising a first expected travel path of a first vehicle, and
a second travel area comprising a second expected travel path of a second vehicle located within a predetermined distance from the vehicle;
determining an overlapping area between the first travel area and the second travel area;
determining a possibility of collision, in the overlapping area, between the first vehicle and the second vehicle being greater than a threshold value; and
causing, based on a determination that the possibility of collision satisfies a second threshold value, the first vehicle to perform an evasive maneuver.

12. The method of claim 11, wherein the determining of the first travel area comprises determining the second travel area by determining an area within a range having a first offset in a lateral direction from the first expected travel path, and
wherein the determining of the second travel area by determining an area within a range having a second offset in the lateral direction from the second expected travel path.

13. The method of claim 12, further comprising:
determining, based on a center line of a lane, at least the first expected travel path or the second expected travel path.

14. The method of claim 12, further comprising:
adjusting the first offset based on a curvature of the first expected travel path; and
adjusting the second offset based on a curvature of the second expected travel path.

15. The method of claim 12, further comprising:
adjusting the first offset based on a speed of the first vehicle; and
adjusting the second offset based on a speed of the second vehicle.

16. The method of claim 12, further comprising:
determining a first point at an intersection between the first expected travel path and the second expected travel path;
determining a second point at a location where the second vehicle first enters the overlapping area between the first travel area and the second travel area;
determining a third point by projecting the second point onto the first expected travel path; and
determining a reference point for determining a time for the first vehicle to enter the overlapping area, wherein the reference point is a point, between the first point and the third point, that the first vehicle is estimated to reach first.

17. The method of claim 16, further comprising:
determining, based on an angle between the first expected travel path and the second expected travel path at the intersection, a direction of approach by the second vehicle; and
determining the second point by determining an earliest point of overlap between the first travel area and the second travel area.

18. The method of claim 16, further comprises:
determining a first time at which the first vehicle is estimated to reach the reference point;
determining a danger period comprising the first time; and
estimating the possibility of collision by determining whether the danger period comprises a second time at which the second vehicle is estimated to reach the overlap area.

19. The method of claim 11, further comprising:
determining, based on the possibility of collision, a drivable area by excluding the overlapping area from the first travel area; and
adjusting the first expected travel path based on the drivable area.

20. The method of claim 19, further comprising:
decelerating the first vehicle based on a determination that the adjusted first expected travel path extends beyond the drivable area.
